(19) United States
(12) Patent Application Publication
(10) Pub. No.: US 2009/0248661 A1
(43) Pub. Date: Oct. 1, 2009

(54) IDENTIFYING RELEVANT INFORMATION SOURCES FROM USER ACTIVITY

(75) Inventors: Mikhail Bilenko, Bellevue, WA (US); Ryen W. White, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/057,491

(22) Filed: Mar. 28, 2008

(51) Int. Cl. G06F 17/30

(52) U.S. Cl. 707/5; 707/E17.108

(57) ABSTRACT

A relevant information source identification technique that exploits a combination of searching and browsing activity of many users to identify relevant resources for future queries. The technique relies on such data to identify relevant information sources for new queries. In one embodiment, the technique is term-based: past queries are decomposed into individual (possibly overlapping) terms and phrases, and the most relevant documents are identified for each phrase from the browsing patterns of users that follow the query. Then, for a new query that consists of several terms or phrases, the most relevant destinations for each term/phrase are combined to produce overall predictions of the best or most relevant sources for the new query. This allows for providing predictions for previously unseen queries, which comprise a large proportion of the overall query volume.

### BACKGROUND

Traditional information retrieval (IR) techniques identify information sources (documents, images, web sites) relevant to a given query by computing the similarity between the query and the sources' contents. However, a number of recent approaches to search/retrieval exploit features beyond those derived from source contents. They utilize features such as the structure of hyperlink graphs, or users' interactions with search engines and subsequent links to results, as well as utilize machine learning methods that combine such features to estimate source relevance.

IR research has a legacy of using term frequencies and term distribution information as the basis for retrieval operations. There is good reason for this: ranking documents based on statistical models of their contents allows for the development of probabilistic ranking methods that quantify relevance to information needs. However, in World Wide Web or Web search, sources of evidence beyond contents have also proven to be useful for ranking documents. Reciprocal hyperlinks between Web pages allow authors to link their pages, sites, and repositories to other relevant sources. Link-analysis algorithms leverage this feature of Web page authorship for the implicit endorsement of Web pages. Link-analysis algorithms are generally either: query independent, where the relative importance of Web pages and Web domains is computed offline prior to query submission, or query-dependent, whereby scores are assigned to documents at retrieval time given their algorithmic matching to the user's query. The key feature of link-analysis algorithms is that they compute the authority value based on the links created by page authors and assume that users traverse this graph in a random or pseudo-intelligent way.

Given the rapid growth in Web usage, it would be useful to leverage the collective browsing behavior of many users as an improvement over random or directed traversals of the Web graph.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The relevant information source identification technique described herein exploits a combination of the searching and browsing activity many of users to identify relevant information sources for new queries. In one embodiment, the technique is term-based: past queries are decomposed into individual (possibly overlapping) terms, and the most relevant documents are identified for each term from the browsing patterns of users that follow a query. Then, for a new query that may consist of several terms, the most relevant destinations for each term are combined to produce overall predictions of the best or most relevant sources of information for the new query. This provides predictions for previously unseen queries, which comprise a large proportion of the overall query volume. Search and browsing data used to build models can be obtained from such sources as toolbar logs, behavior logs of various search engine users, or from other sources.

In the following description of embodiments of the disclosure, reference is made to the accompanying drawings which form a part hereof, and in which are shown, by way of illustration, specific embodiments in which the technique may be practiced. It is understood that other embodiments may be utilized and structural changes may be made without departing from the scope of the disclosure.

### DESCRIPTION OF THE DRAWINGS

The specific features, aspects, and advantages of the disclosure will become better understood with regard to the following description, appended claims, and accompanying drawings where:

FIG. 1 provides an overview of one possible environment in which searches for information sources on a network are typically carried out.

FIG. 2 is a diagram depicting one exemplary architecture in which one embodiment of the relevant information source identification technique can be employed.

FIG. 3 is a flow diagram depicting a generalized exemplary embodiment of a process for employing one embodiment of the relevant information source identification technique.

FIG. 4 is a flow diagram depicting another exemplary embodiment of a process for employing one embodiment of the relevant information source identification technique.

FIG. 5 is a schematic of a search trail depicted as a Web behavior graph.

FIG. 6 is a schematic of a probabilistic relevance model employed in one embodiment of the relevant information source identification technique.

FIG. 7 is a schematic of another probabilistic relevance model with a random walk extension employed in one embodiment of the relevant information source identification technique.

FIG. 8 is a schematic of an exemplary computing device in which the relevant information source identification technique can be practiced.

### DETAILED DESCRIPTION

In the following description of the relevant information source identification technique, reference is made to the accompanying drawings, which form a part thereof, and which is shown by way of illustration examples by which the relevant information source identification technique may be practiced. It is to be understood that other embodiments may be utilized and structural changes may be made without departing from the scope of the claimed subject matter.

### 1.0 Relevant Source Identification Technique

The relevant information source identification technique described herein exploits a combination of searching and browsing activities of many users to identify relevant resources for future queries. It provides predictions for previously unseen queries, which comprise a large proportion of the overall query volume. Search and browsing data used to build models can be obtained, for example, from such sources as toolbar logs, e.g., behavior logs of various search engine users.

In a most general sense, one embodiment of the relevant source identifying technique operates as follows:
1) From past usage data, a model is constructed that associates every term or phrase tᵢ in a search query with relevant sources. Weights are computed to quantify the degree of relevance of each source to a given term.
2) Every new incoming query is then represented as a set of terms.
3) Relevant sources for all terms in the new query are predicted and the predictions for the terms are combined to produce the overall prediction of most relevant sources for a given search query.

Specific procedures that instantiate this general approach may differ in how they compute weights that associate terms with sources in step (1), and in how they combine predictions of sources from individual terms in step (3). Various embodiments of the relevant source identifying technique are described in the paragraphs below.

The various embodiments of the relevant information source identification technique provide for many unexpected results and advantages. For example, relevant sources for search queries that have not yet occurred can be predicted.

### 1.1 Search Environment

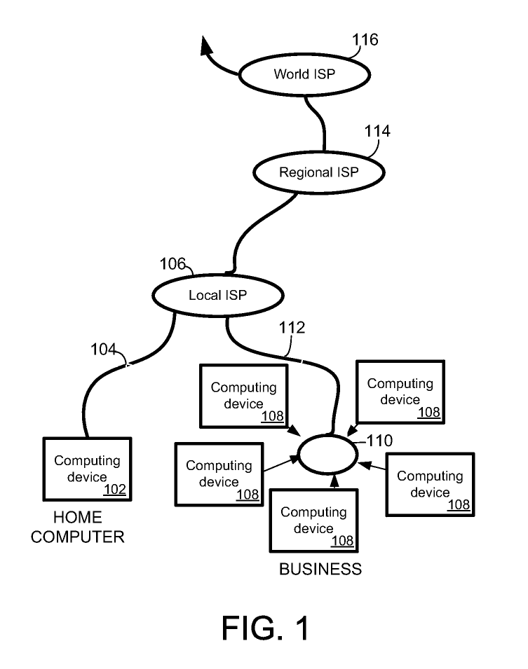

FIG. 1 provides an overview of an exemplary environment in which searches on the Web or other network, may be carried out. Typically, a user searches for information on a topic on the Internet or on a Local Area Network (LAN) (e.g., inside a business).

The Internet is a collection of millions of computers linked together and in communication on a computer network. A home computer 102 may be linked to the Internet or Web using a telephone line, a digital subscriber line (DSL), a wireless connection, or a cable modem 104 that talks to an Internet Service Provider (ISP) 106. A computer in a larger entity such as a business will usually connect to a local area network (LAN) 110 inside the business. The business can then connect its LAN 110 to an ISP 106 using a high-speed line like a T1 line 112. ISPs then connect to larger ISPs 114, and the largest ISPs 116 typically maintain networks for an entire nation or region. In this way, every computer on the Internet can be connected to every other computer on the Internet.

The World Wide Web (referred sometimes as the Web herein) is a system of interlinked hypertext documents accessed via the Internet. There are billions of pages of information and images available on the World Wide Web. When a person conducting a search seeks to find information on a particular subject or an image of a certain type they typically visit an Internet search engine to find this information on other Web sites via a browser. Although there are differences in the ways different search engines work, they typically crawl the Web (or other networks or databases), inspect the content they find, keep an index of the words they find and where they find them, and allow users to query or search for words or combinations of words in that index. Searching through the index to find information typically involves a user building a search query and submitting it through the search engine via a browser or client-side application. Text and images on a Web page returned in response to a query can contain hyperlinks to other Web pages at the same or different Web site.

### 1.2 Exemplary Architecture

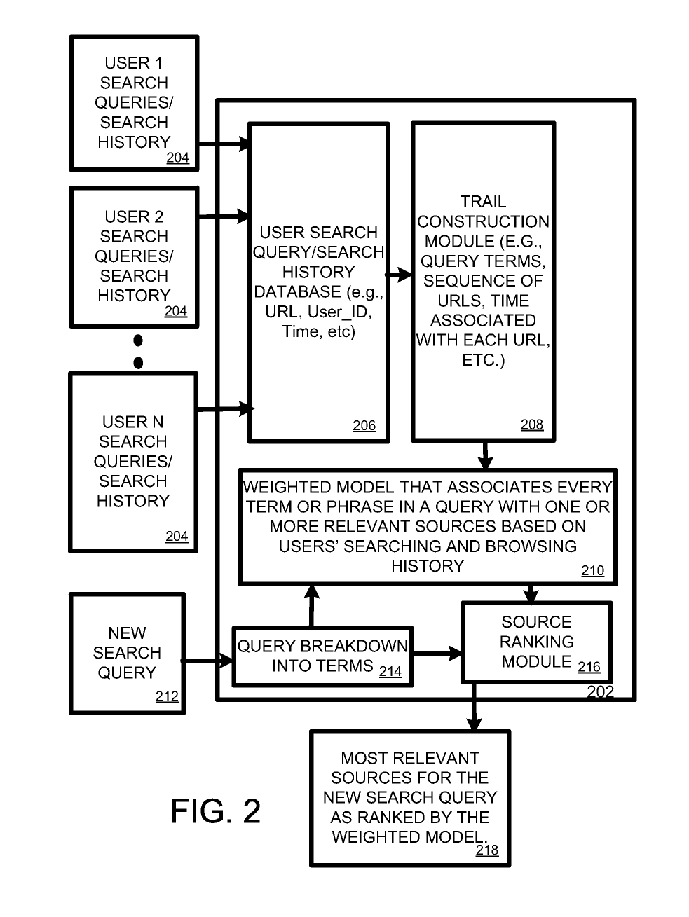

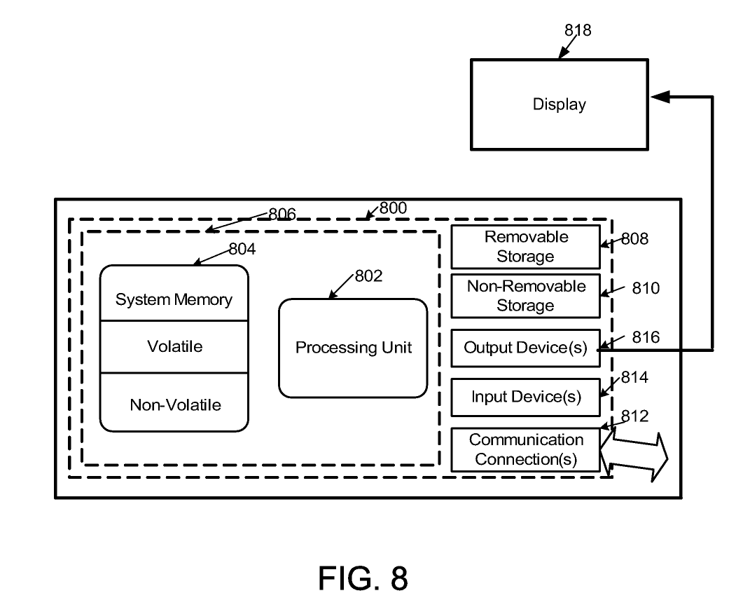

One exemplary architecture 200 (residing on a computing device 800 such as discussed later with respect to FIG. 8) in which the relevant information source identification technique can be employed is shown in FIG. 2. In this exemplary architecture multiple user search queries and associated browsing histories 204 are input into a relevant information source identification module 202. The relevant information source identification module includes a user search query/browsing history database 206 which includes each user's search queries and associated browsing histories. In one embodiment the search query and search history database includes parameters such as Uniform Resource Locators (URLs) the user visited, user IDs and the time spent on each URL (source), among other parameters. The information in the user search query/browsing history database 206 is input into a search trail construction module 208 which creates search trails for each search query. For example, each search trail includes a query, a sequence of URLs accessed by a user including the time spent on each URL and tokenizations of the search query terms. The search trails created by the trail construction module 208 are used to create a weighted model that associates every term or phrase in a query with one or more relevant sources based on users' search and browsing history in a model construction module 210. When a new search query 212 is entered, it is broken into terms in a query breakdown module 214 and the weighted model and the query terms are used to rank the relevance of sources in a ranking module 216 which predicts the most relevant sources given the terms of the new query. The most relevant sources for the search query are then output, such as, for example, by displaying them to a user 218.

### 1.3 Exemplary Processes Employing the Relevant Information Source Identification Technique

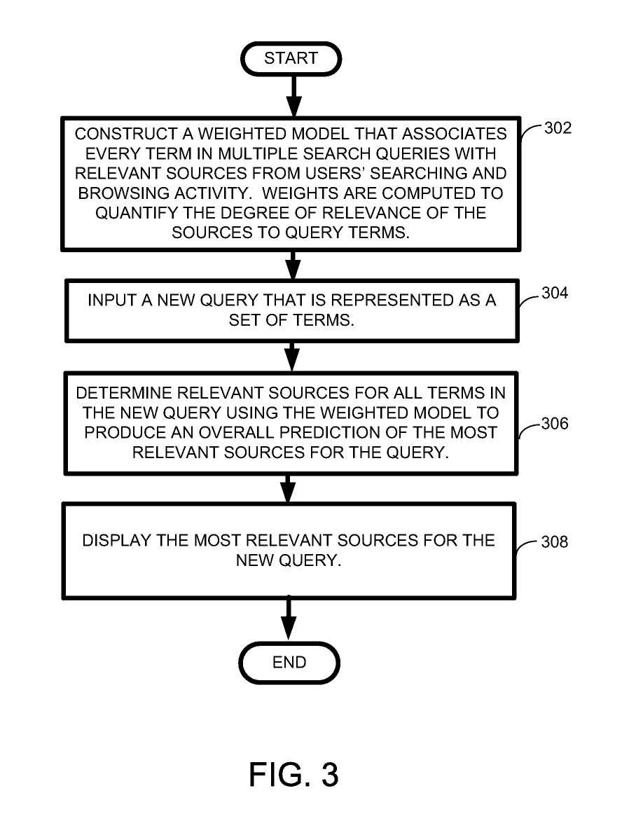

A general exemplary process employing the relevant information source identification technique is shown in FIG. 3. As shown in FIG. 3, process action 302, a weighted model that associates every term or phrase in a search query with relevant sources from users' searching and browsing activity is created. Weights are computed to quantify the degree of relevance of the source documents to each term of the query. Once the model is created, a new query is input that is represented as a set of terms (process action 304). Relevant sources for all terms in the new query are determined using the weighted model to determine an overall prediction of the most relevant sources for the query (process action 306). These results can be presented to the user who entered the new query, for example, with the most relevant sources in order of determined relevance (process action 308).

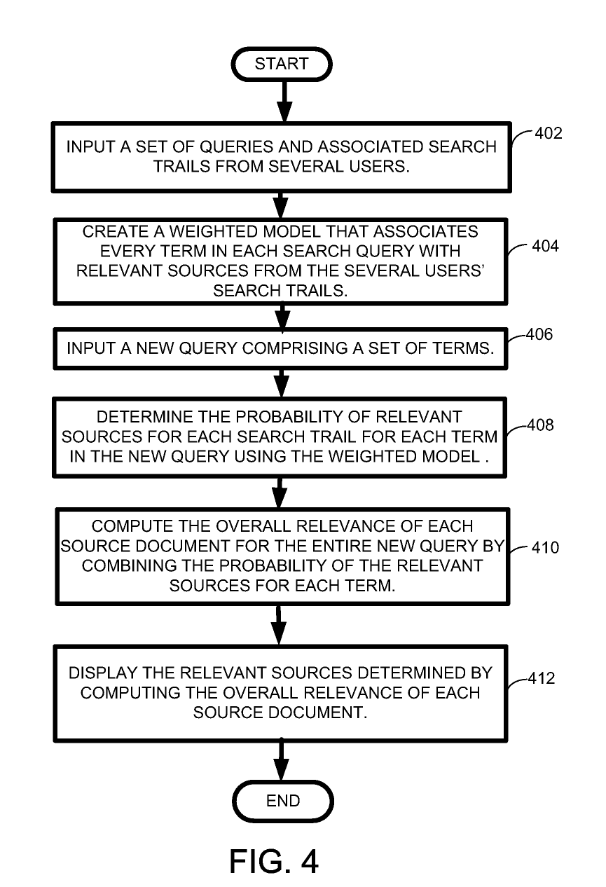

FIG. 4 depicts another exemplary process employing the relevant information source identification technique. As shown in process action 402, a set of queries and associated search trails from several users are input. (These search trails will be discussed in greater detail later.) A weighted model that associates every term or phrase in each search query with relevant sources from the several users' search trails is created (process action 404). A new query comprising a set of terms is input (process action 406). The probability of relevant sources for each term in the new query is determined using the weighted model (process action 408). The overall relevance of each source document for the entire new query is computed by combining the probability of relevant sources for each term (process action 410). The sources for the new query can then be displayed, preferably ranked in order of their overall relevance (process action 412).

It should be noted that many alternative embodiments to the discussed embodiments are possible, and that steps and elements discussed herein may be changed, added, or eliminated, depending on the particular embodiment. These alternative embodiments include alternative steps and alternative elements that may be used, and structural changes that may be made, without departing from the scope of the disclosure.

### 1.4 Exemplary Embodiments and Details

Various alternate embodiments of the relevant information source identification technique can be implemented. The following paragraphs provide details and alternate embodiments of the exemplary architecture and processes presented above.

### 1.4.1 User Activity Logs/Search Trails

Web browser toolbars have become increasingly popular in recent years, providing users with quick access to extra functionality such as the ability to search the Web without the need to visit a search engine homepage, or the option to search within visited pages for items of interest. Examples of popular toolbars include those affiliated with search engines, as well as those targeted at users with specific interests. To provide the value-added browser features, most popular toolbars log the history of users' browsing behavior on a central server for users who consented to such logging. Each log entry typically includes an anonymous session identifier, a timestamp, and the URL of the visited Web page.

From these and similar interaction logs, user trails can be reconstructed. For each user, interaction logs can be grouped based on browser identifier information. Within each browser instance, user navigation can be summarized as a path known as a browser trail, from the first to the last Web page visited in that browser session. Located within some of these browser trails are search trails that originate with a query submission to a search engine. It is these search trails that the relevant information source identification technique uses in the procedures described in the following sections to create the weighted model(s) used in identifying relevant sources for a given query.

After originating with a query submission to a search engine, search trails proceed until a point of termination where it is assumed that the user has completed their information-seeking activity or has addressed a particular aspect of their information need. In one embodiment, trails contain pages that are either search result pages, or pages connected to a search result page (e.g., via a sequence of clicked hyperlinks). In one embodiment, extracting search trails using this methodology also goes some way toward handling multi-tasking, where users run multiple searches concurrently. Since users may open a new browser window (or tab) for each task, each task has its own browser trail, and a corresponding distinct search trail.

More specifically, given logs of user activity data expressed as sequences of browsing patterns, a dataset of N search trails can be constructed, D={qᵢ→(dᵢ₁, . . . , dᵢₖ)}, i=1 . . . N, where each trail begins with a query qᵢ to a search engine and continues with a sequence of viewed documents, dᵢ₁, . . . , dᵢₖ, until a termination criterion (such as another query or the browser window closing) has been satisfied.

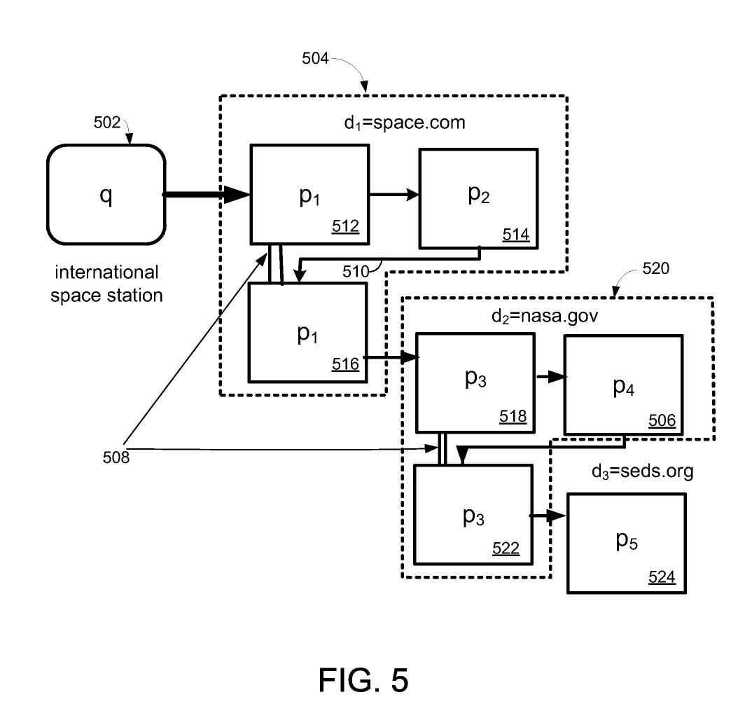

In one embodiment of the technique, to reduce the amount of “noise” from pages unrelated to the active search task that may corrupt the data, search trails are terminated when one of the following events occurs: (1) a user submits a new search query; (2) a user navigates to their homepage, initiates a Web-based email session, or visits a page that requires authentication, types a URL or visits a bookmarked page; (3) a page is viewed for more than 30 minutes with no activity; or (4) the user closes the active browser window. On average, in one working embodiment, there are around 5 steps per search trail. To illustrate the concept, a search trail is expressed as a Web behavior graph, an example of which is shown in FIG. 5. This graph represents user activity within a search trail, from the originating query 502 to the point at which one of the four exemplary termination criteria listed above is met. The nodes of the graph represent Web pages that the user has visited. Vertical lines represent backtracking to an earlier state 508. A “back” arrow 510, such as that below node p₂, implies that the user revisited a page seen earlier in the search trail. Temporal sequence of events continues from left to right, and then from top to bottom.

One goal of the relevant source identifying technique is to exploit a dataset of search trails for identifying relevant sources (e.g., Web sources) for future queries, where “sources” may include, for example, documents, images and web sites. The simplest approach is to store actual queries along with associated sources that were browsed in subsequent trails, giving highest rankings to documents with highest visitation counts or longest cumulative dwell times. However, because a significant number of queries are unique, this “lookup” approach only works for a fraction of incoming queries.

Thus, identifying relevant information sources for new queries requires developing term-based models similar to those that have traditionally been used in standard Information Retrieval (IR). More specifically, every query q can be represented as an unordered set of k terms or phrases, q={t₁, . . . , tₖ}, with associated weights, that is obtained via tokenization and/or additional processing steps that may include token normalization, query expansion, named entity recognition, and construction of n-grams (e.g., bi-grams or multi-part terms). Some embodiments of the relevant source identification technique use this representation of queries to process large datasets of search trails, so that predictions of relevant sources can be made for future queries.

In FIG. 5, the trail begins with the query 502 [international space station] submitted to a search engine. From the search engine result page, the user browses to page p₁ 512 in the space.com web site (d₁) 504, jumps to another page p₂ 514 in the same web site, and then returns to the original page p₁ 516. From there, the user follows a link to page p₃ 518 in nasa.gov (d₂) 520, then again views a page (p₄) 506 before jumping back to entry point (p₃) 522, from where a link is followed to the homepage of Students for the Development and Exploration of Space (domain d₃=seds.org) p₅ 524, where the search trail terminates. This example demonstrates the richness of post-search browsing behavior, which involves navigation across a number of pages in multiple domains over an extended time period.

### 1.4.2 Heuristic Retrieval Model

One embodiment of the relevant source identification technique employs a heuristic model in determining sources relevant to a given query. This embodiment goes through search trails, and assigns non-zero term/phrase weights to all sources that occur in trails that follow queries containing these terms. The weighting formula is similar to one traditionally employed in information retrieval for assigning weights to terms contained in documents—thus, each source is effectively treated as a document that contains terms that come from queries that start trails leading to the destination. Then, the total weight of term/phrase tᵢ for source dⱼ is the sum of weight contributions from all trails that start with a query containing tᵢ and that include dⱼ in the browsing sequence:

$$w ( {t}_{i} , {d}_{j} ) = {\sum }_{τ ∈ D} f ( τ , {t}_{i} {d}_{j} )$$

Any combination of the number of visits or dwell time on the source dⱼ can be used to compute the contribution of an individual trail τ to the weight of term/phrase tᵢ for example, the logarithm of total dwell time on dⱼ in a given trail: f(τ,tᵢ,dⱼ)=log time(τ,dⱼ). Weights can additionally be transformed to obtain better performance, e.g., scaled by the maximal weight of token tᵢ across all sources:

$$w ( {t}_{i} , {d}_{j} ) = \frac{{\sum }_{τ ∈ D} f ( τ , {t}_{i} , {d}_{j} )}{{max}_{\text{?}} {\sum }_{τ ∈ D} f ( τ , {t}_{i} , {d}_{j} )}$$

$$\text{?} \text{indicates text missing or illegible when filed}$$

Then, for an incoming query comprised of k terms, q={t₁, . . . , tₖ}, relevant sources can be identified by computing the overall relevance score for every source that is relevant to terms t₁, . . . , tₖ:

$$Relevance ( {d}_{j} , q ) = {\sum }_{\text{?} \text{?}} w ( {t}_{i} , {d}_{j} ) w ( {t}_{i} , q )$$

$$\text{?} \text{indicates text missing or illegible when filed}$$

where [symbol] is the relative weight of term in the query, which typically assigns higher weight to more specific (rare) terms, for example by using inverse query frequency weighting:

$$w ( {t}_{i} , q ) - log \frac{\text{?} - n ( {t}_{i} ) + 0.5}{n ( {t}_{i} ) + 0.5}$$

$$\text{?} \text{indicates text missing or illegible when filed}$$

where N_{q} is the total number of queries, and [symbol] is the number of queries that include term tᵢ.

### 1.4.3 Probabilistic Model

An alternative to the heuristic algorithm is based on a probabilistic model, where every term \hat{t}ᵢ is associated with a probability distribution over sources, p(dⱼ|\hat{t}ᵢ) that corresponds to the likelihood of source dⱼ being relevant following a query that contains term \hat{t}ᵢ For every new query \hat{q}={\hat{t}ᵢ . . . \hat{t}ₙ}, a probability of generating term \hat{t}ᵢε\hat{q} is computed as p(\hat{t}ᵢ|\hat{q}); then relevance of source dⱼ can be computed as the probability of destination being relevant to the query assuming term independence, leading to a formulation analogous to the heuristic approach above:

$$Relevance P ( {d}_{j} \vert \hat{q} ) = p ( {d}_{j} \vert \hat{q} ) = {\sum }_{{t}_{i} ∈ q} p ( {\hat{t}}_{i} \vert \hat{q} ) p ( {d}_{j} \vert {\hat{t}}_{i} )$$

The probabilities p(dⱼ|\hat{t}ᵢ) for term-source pairs can be instantiated based on all search trails that contain term \hat{t}ᵢ and proceed to source dⱼ in the browsing sequence. Probabilities can be computed in different ways based on dwell time and visit counts, for example as:

$$p ( {d}_{j} \vert {\hat{t}}_{i} ) = \frac{{\sum }_{τ} log ( time ( τ , {d}_{j} ) )}{\sum {d}_{k} {\sum }_{τ} log ( time ( τ , {d}_{j} ) )}$$

where τ are all trails that start with queries that include term \hat{t}ᵢ. Effectively, this formula computes the probability of spending unit-log-time on destination dⱼ among all destinations on which users spent time following queries that include term \hat{t}ᵢ.

### 1.4.4 Probabilistic Model Extended with Random Walks

The above procedure using the probabilistic model can be extended to give higher scores to destinations that are relevant to more than one term in the query by giving them a higher weight. To achieve this, the relevance score above can be augmented by additional summands that model a “random walk.” These summands correspond to each source relevant to query terms sampling terms based on some distribution p(\hat{t}ᵢ|dⱼ), and selected terms again selecting relevant sources. As a result, sources that correspond to multiple query terms obtain a higher weight than in the original probabilistic model. With the additional summands, relevance score for sources sampled from the original query terms becomes:

$${Rel}_{P + RW} ( {d}_{j} , \hat{q} ) = {\sum }_{{\hat{t}}_{j} ∈ q} p ( {\hat{t}}_{i} \vert \hat{q} ) ( α p ( {d}_{j} \vert {\hat{t}}_{i} ) + ( 1 - α ) {\sum }_{{\hat{t}}_{j} ∈ q , {d}_{j}} p ( {d}_{j} \vert {\hat{t}}_{i} ) p ( {\hat{t}}_{i} \vert {d}_{j} ) p ( {d}_{j} \vert {\hat{t}}_{l} )$$

where α is the relative weight given the original probabilistic model, while (1−α) correspondingly adds weight for the random walk extension.

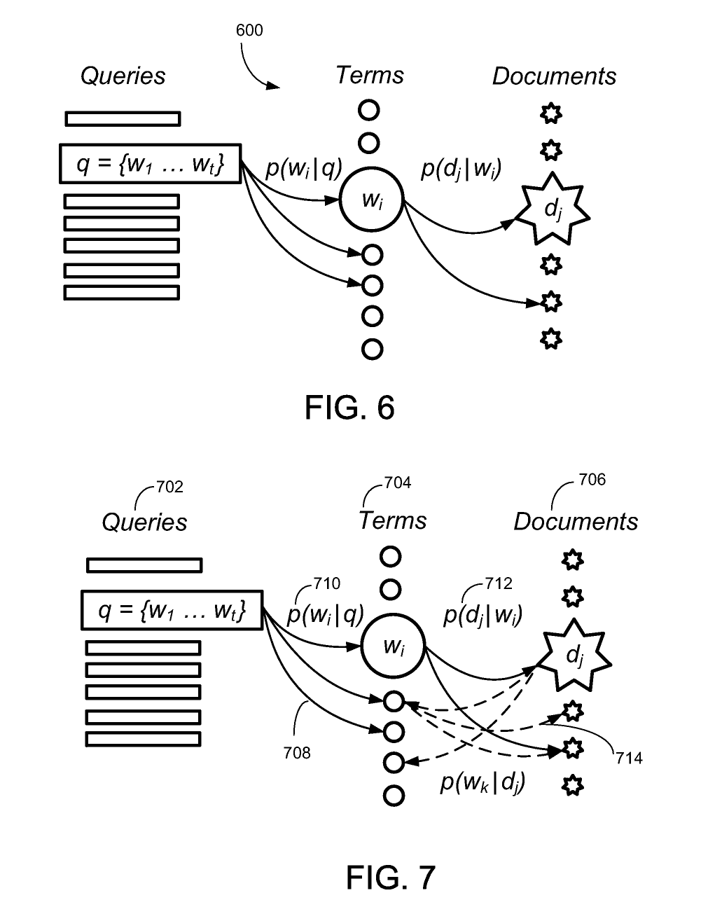

FIGS. 6 and 7 illustrate the probabilistic model without the random walk 600 and with the random walk 700, respectively. More specifically, the process of selecting a document relevant to a query in the probabilistic model described in the previous section can be viewed as a two-step random walk in a tri-partite graph formed by queries 702, query terms 704, and documents 706. FIG. 7 illustrates this view with solid lines 708 representing the transitions corresponding to the query term probability distribution 710 and term-document probability distribution 712. For computational efficiency, a simple enhancement that adds four-step walks alongside the two-step walks in the basic probabilistic model above is considered; in FIG. 7, these are represented by dotted lines that go back to term nodes from document nodes and then return to document nodes. After reaching a document in the second step of the random walk from the standard model, the walk is either absorbed with probability α, or proceeds to sample from all terms via which the document was reached, and continues to other documents reached from these terms. Then, relevance of a document dⱼ for a given query \hat{q} is computed via the likelihood of the random walk ending in node dⱼ.

### 1.5 Alternate Embodiments

Various alternate embodiments of the technique described herein are possible. For example, alternative derivations of relevance functions based on training datasets of search trails can be constructed both heuristically, as well as using different probabilistic formulations. For example, query-term distributions different from those described herein may be used. Additionally, variations of the random-walk formulation described may be employed. In addition, leveraging contextual information available in a browser window before and after the search trails (i.e., before the first query and after a defined termination event) is also possible.

There are a number of tasks that can exploit query-specific document authority, transcending relevance estimation for Web search. User-validated authority may be useful for identification of Web spam. Because users are unlikely to visit non-informative resources often, and will leave them almost immediately, using activity logs may provide valuable evidence to Web spam detection algorithms. Alternatively, authoritative sites not appearing in a search engine's index could be added to the index automatically, and used as additional seeds for future crawling operations.

While the results in the previous sections demonstrate that the proposed models are capable of leveraging large datasets of user search and browsing behavior to identify relevant documents or web sites for queries, they do not address the issue of practical usefulness of the methods in the context of improving search engine results. Modern search engines typically rely on ranking algorithms based on machine learning approaches, which allow incorporating hundreds and thousands of features that exploit diverse sources of evidence. These features may capture such signals as similarity between the query and document content, link structure and properties such as anchor text, overall page quality, and features derived from user interactions with the search engine. Relevant destinations (e.g., sources) can be used as a feature (“source of signal”) in ranking systems that combine multiple such signals. The relevance scores for pages and sites obtained using the relevant source identification technique can be fed into a larger such ranking system.

### 2.0 The Computing Environment

The relevant information source identification technique is designed to operate in a computing environment. The following description is intended to provide a brief, general description of a suitable computing environment in which the relevant information source identification technique can be implemented. The technique is operational with numerous general purpose or special purpose computing system environments or configurations. Examples of well known computing systems, environments, and/or configurations that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, programmable consumer electronics, network PCs, minicomputers, mainframe computers, distributed computing environments that include any of the above systems or devices, and the like.

FIG. 8 illustrates an example of a suitable computing system environment. The computing system environment is only one example of a suitable computing environment and is not intended to suggest any limitation as to the scope of use or functionality of the present technique. Neither should the computing environment be interpreted as having any dependency or requirement relating to any one or combination of components illustrated in the exemplary operating environment. With reference to FIG. 8, an exemplary system for implementing the relevant information source identification technique includes a computing device, such as computing device 800. In its most basic configuration, computing device 800 typically includes at least one processing unit 802 and memory 804. Depending on the exact configuration and type of computing device, memory 804 may be volatile (such as RAM), non-volatile (such as ROM, flash memory, etc.) or some combination of the two. This most basic configuration is illustrated in FIG. 8 by dashed line 806. Additionally, device 800 may also have additional features/functionality. For example, device 800 may also include additional storage (removable and/or non-removable) including, but not limited to, magnetic or optical disks or tape. Such additional storage is illustrated in FIG. 8 by removable storage 808 and non-removable storage 810. Computer storage media includes volatile and nonvolatile, removable and non-removable media implemented in any method or technology for storage of information such as computer readable instructions, data structures, program modules or other data. Memory 804, removable storage 808 and non-removable storage 810 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 800. Any such computer storage media may be part of device 800.

Device 800 has a display 818, and may also contain communications connection(s) 812 that allow the device to communicate with other devices. Communications connection(s) 812 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. The term computer readable media as used herein includes both storage media and communication media.

Device 800 may have various input device(s) 814 such as a keyboard, mouse, pen, camera, touch input device, and so on. Output device(s) 816 such as speakers, a printer, and so on may also be included. All of these devices are well known in the art and need not be discussed at length here.

The relevant information source identification technique may be described in the general context of computer-executable instructions, such as program modules, being executed by a computing device. Generally, program modules include routines, programs, objects, components, data structures, and so on, that perform particular tasks or implement particular abstract data types. The relevant information source identification technique may be practiced in distributed computing environments where tasks are performed by remote processing devices that are linked through a communications network. In a distributed computing environment, program modules may be located in both local and remote computer storage media including memory storage devices.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

Wherefore, what is claimed is:

1. A computer-implemented process for finding relevant sources of information for a search query, comprising:
constructing a weighted model that associates every term in multiple search queries with relevant sources from multiple users' searching and browsing activity;
inputting a new query that is represented as a set of terms;
determining relevant sources for all terms in the new query using the weighted model to determine an overall prediction of the most relevant sources for the query; and
displaying the determined relevant sources for the new query.

2. The computer-implemented process of claim 1 wherein creating the weighted model further comprises computing weights to quantify the degree of relevance of each of the sources to each term of the multiple queries.

3. The computer-implemented process of claim 1 wherein a source document is a web site, a web page, a document, or an image.

4. The computer-implemented process of claim 3 further comprising assigning a higher weight to more rare terms that are more likely to differentiate between relevant and non-relevant sources.

5. The computer-implemented process of claim 2 wherein the weights to quantify the degree of relevance of each of the sources are computed by using the number of user visits to a source for a given term.

6. The computer-implemented process of claim 2 wherein the weights to quantify the degree of relevance of each of the sources are computed by using the dwell time of user visits to a source for a given term.

7. The computer-implemented process of claim 1 further comprising displaying the most relevant sources in order of determined relevance.

8. The computer-implemented process of claim 1 further comprising creating the weighted model using a heuristic method.

9. The computer-implemented process of claim 1 further comprising creating the weighted model using a probabilistic model where every term is associated with a probability distribution over sources that corresponds to the likelihood of a source being relevant following a query that contains a given term.

10. The computer-implemented process of claim 1 further comprising creating the weighted model that is a random walk probabilistic model that gives higher scores to sources that are relevant to more than one term in a query by giving these sources higher weights.

11. A computer-implemented process for finding relevant sources of information for a search query on a network, comprising:
inputting a set of queries and associated search trails from several users;
creating a weighted model that associates every term or phrase in each search query with relevant sources from the several users' search trails;
inputting a new query comprising a set of terms;
determining probability of relevant sources for each search trail for each term in the new query using the weighted model; and
determining the overall relevance of each source document for the entire new query by combining the probability of relevant sources for each term.

12. The computer-implemented process of claim 11 further comprising displaying the sources for the new query, ranked in order of their overall relevance.

13. The computer-implemented process of claim 11 wherein each search trail further comprises pages that are search results and pages connected to a search result page via a sequence of hyperlinks.

14. The computer-implemented process of claim 13 wherein the overall relevance of one or more sources is used as one or more features within a learnable ranking system that includes multiple features based on different sources of evidence.

15. The computer-implemented process of claim 11 further comprising using a combination of the number of user visits or user dwell time on one or more sources to compute the contribution of an individual search trail to the weight of a term.

16. A system for finding relevant sources of information on a network in response to a search query, comprising:
a general purpose computing device;
a computer program comprising program modules executable by the general purpose computing device, wherein the computing device is directed by the program modules of the computer program to,
receive a set of users' search queries and associated search result histories;
create search trails that each include a query, a sequence of URLs accessed by a user including the time spent on each URL and tokenizations of the search query terms;
create a weighted model that associates every term in a query with one or more relevant sources based on users' searching and browsing history;
input a new search query, broken into terms;
use the weighted model to rank the relevance of sources by predicting the most relevant sources for each of the terms of the new query;
output the most relevant sources for the new search query.

17. The system of claim 16 further comprising tokenizations of query terms that are overlapping.

18. The system of claim 16 wherein the weight of a term for a source is the sum of the weight contributions from all search trails that start with a query and include the source in the search trail.

19. The system of claim 16 wherein the number of visits to a source and the dwell time on a source are used to compute the contribution of an individual search trail to the weight of a term in a query.

20. The system of claim 16 wherein creating the weighted module further comprises assigning non-zero term weights to all sources that occur in search trails that follow a query.
